(19) United States
(12) Patent Application Publication
(10) Pub. No.: US 2026/0078801 A1
(43) Pub. Date: Mar. 19, 2026

(54) HYDRAULIC BEARING AND PROCESS FOR MANUFACTURING A HYDRAULIC BEARING

(71) Applicant: Sumitomo Riko Company Limited, Komaki-Shi (JP)

(72) Inventors: Miro Eppli, Bad Soden-Salmünster (DE); Jozsef Kondor, Künzell (DE)

(73) Assignee: Sumitomo Riko Company Limited, Komaki-Shi (JP)

(21) Appl. No.: 19/309,336

(22) Filed: Aug. 25, 2025

(30) Foreign Application Priority Data
Sep. 16, 2024 (DE) 102024126543.4

(51) Int. Cl. F16C 32/06; B29C 45/14; B29L 31/04

(52) U.S. Cl. CPC F16C 32/0633; B29C 45/14754; B29C 2045/1477; B29L 2031/04

(57) ABSTRACT

A hydraulic bearing, comprising: an inner core, a cage, an elastomer body extending between the inner core and the cage, and an outer sleeve which encloses the cage. The elastomer body has: first and second fluid chamber recesses filled with a working fluid, forming first and second fluid chambers that are fluidically connected to each other via a fluid channel such that fluid exchange takes place between the first and second fluid chambers via the fluid channel upon relative displacement of the inner core and the cage. The inner core has: first and second inner core stop projections, extending into the first fluid chamber and the second fluid chamber, respectively. The cage has first and second cage axial stop projections that cooperate with the first and second cage axial stop projections to limit the relative displacement of the inner core and the cage with respect to each.

### CROSS-REFERENCE TO RELATED APPLICATIONS

This application claims the priority of German Patent Application No. DE 102024126543.4, filed September 16, 2024, the entire contents of which are hereby incorporated by reference.

### TECHNICAL FIELD

The disclosure relates to a hydraulic bearing, in particular a hydraulic subframe bearing, and to a method for manufacturing a hydraulic bearing, in particular a hydraulic subframe bearing.

### BACKGROUND

Hydraulic bearings are frequently used to connect a first component to a second component, allowing but dampening relative movements, particularly vibrations, with respect to each other. Due to the use of elastomer material, the hydraulic bearing provides restoring spring forces as well as damping forces actively generated by dissipation in the bearing. Hydraulic bearings typically have two hydraulic chambers connected to each other via a channel to allow fluid exchange between these hydraulic chambers.

In vehicle construction, the chassis components and, inter alia, aggregate or power unit elements are usually secured to a subframe. Here, the subframe can be mounted relative to the vehicle cabin using hydraulic subframe bearings in a radial and/or axial direction of the hydraulic bearings. This radial and axial direction depends on the construction and position in the vehicle and, in an installed state of the hydraulic bearing in the vehicle, often corresponds to a horizontal and vertical direction of vehicle movement. Here, for the hydraulic bearings, stops and stop plates are usually used in the radial and axial directions as additional components outside the hydraulic bearing to limit the maximum linear bearing travel in these directions. The additional stops and stop plates increase the complexity of manufacturing and installation of the hydraulic bearings.

It is therefore an object of the present disclosure to provide a hydraulic bearing and the manufacture thereof, which replicates the function of known hydraulic bearings with limited bearing movement with less complexity and lower costs. This object is achieved by the independent claims. Preferred embodiments are evident from the respective dependent claims.

A first aspect for achieving the object of the present disclosure relates to a hydraulic bearing, comprising: an inner core, a cage which surrounds the inner core, an elastomer body which extends between the inner core and the cage and elastically connects them to each other to allow relative displacement of the inner core and the cage with respect to each other in a first axial direction, a second axial direction opposite to the first axial direction, a first radial direction and a second radial direction opposite to the first radial direction, respectively, and an outer sleeve which encloses the cage, wherein the elastomer body has: first and second fluid chamber recesses, wherein the first and second fluid chamber recesses are each filled with a working fluid and bounded radially outwardly by the outer sleeve to form first and second fluid chambers, respectively, wherein the first and second fluid chambers are fluidically connected to each other via a fluid channel and are designed such that fluid exchange takes place between the first and second fluid chambers via the fluid channel upon relative displacement of the inner core and the cage with respect to each other in the first and second radial directions, respectively, wherein the inner core has: first and second inner core stop projections, wherein the first inner core stop projection extends in the first radial direction into the first fluid chamber and the second inner core stop projection extends in the second radial direction into the second fluid chamber, wherein the cage has: first and second cage axial stop projections, wherein the first and second inner core stop projections cooperate with the first and second cage axial stop projections, respectively, so as to limit the relative displacement of the inner core and the cage with respect to each other in the first axial direction.

Advantageously, the bearing according to the disclosure can be manufactured in a simpler, more compact, and more cost-effective manner than conventional bearings of this type, particularly as subframe bearings. Here, the bearing according to the disclosure requires no additional stops or stop plates during mounting. The complexity of the construction is reduced by reducing the number of individual components of the hydraulic bearing, while simultaneously limiting the maximum linear bearing travel in a predetermined axial direction of the hydraulic bearing.

In the context of this application, all spatial direction specifications “top”, “bottom”, and “vertical” refer to the z-axis of a three-dimensional coordinate system, the origin of which is preferably located approximately at the center of mass of the bearing according to the disclosure and which is oriented such that the z-axis represents one of the principal axes of inertia of the bearing. Accordingly, the term “axial” or “axial direction” refers, on the one hand, to the z-axis, and the term “radial” or “radial direction” refers, on the other hand, to the x-y plane spanned by the x- and y-axes of the coordinate system, which extends orthogonally to the z-axis. This means that “radial” refers to direction specifications perpendicular to the z-axis. The term “horizontal” also refers to the x-y plane. In the case of the bearing according to the disclosure, the term “transverse” refers to directions along the x-y plane or parallel to the x-y plane, whereas the term “longitudinal” refers to directions along or parallel to the z-axis.

The term “surrounded” in the context of this application can mean that the cage of the bearing according to the disclosure frames, fences, or encircles the inner core and partially delimits the inner core in the radial direction and in the circumferential direction around the z-axis. This means in a state of the bearing without an elastomer body, the cage can represent a radial boundary for the inner core. However, the term “enclose” in the context of this application can mean that the outer sleeve completely limits the cage in the radial direction and in the circumferential direction for the height of the cage in the vertical direction, thus encasing the cage.

The hydraulic bearing has the outer sleeve and a vulcanization component or cast component, wherein the outer sleeve at least partially encloses the vulcanization component. Here, the term “outer sleeve” is to be understood such that the outer sleeve can be mounted on an external component or forms part of an external component, such as a frame portion or handlebar, into which the vulcanization component is mounted or pressed. The hydraulic bearing or outer sleeve can be formed to be cylindrical or substantially cylindrical. The hydraulic bearing can also be formed to be conical or almost tapered, or the axial end sides of the hydraulic bearing, i.e. the surfaces at the two ends of the longitudinal axis that extend perpendicular to the longitudinal axis up to the outside of the hydraulic bearing, can be formed to be elliptical, rectangular, or in a shape suitable for a hydraulic bearing, instead of a circular shape. The hydraulic bearing can also be referred to as a hydro bearing.

The vulcanization component of the hydraulic bearing has at least the inner core, the cage, and the elastomer body. Here, the elastomer body can be formed as a vulcanization component or cast component in an injection molding process or by casting. The outer shape of the vulcanization component is formed such that the vulcanization component can be mounted and, in particular, pressed into the outer sleeve during manufacture of the hydraulic bearing, and the inner side of the outer sleeve surrounds and/or delimits the vulcanization component to the outside. The inner core of the vulcanization component is surrounded by the cage at least in the radial direction, and the elastomer body elastically connects the inner core to the cage. In particular, the inner core and the cage are partially or completely embedded in the elastomer body.

The hydraulic bearing is designed such that it allows relative displacement of the inner core and the cage with respect to each other in a first axial direction and a second axial direction opposite to the first axial direction, as well as in its radial directions. The hydraulic bearing can preferably dampen displacement of the inner core and the cage in a predetermined first radial direction and a second radial direction opposite to, and in particular diametrically opposite to, the first radial direction.

The inner core can have an axial fixture part and at least the first and second inner core stop projections and can be made of a dimensionally stable material, such as a metal or plastic, in particular aluminum. Here, the inner core can be integrally formed and, in particular, can be manufactured as a single-piece component in a single processing step using an injection molding or (die-)casting method. For this purpose, the inner core can be formed to be substantially undercut-free in at least two mutually perpendicular radial directions and in both axial directions. The axial fixture part can be formed to be substantially cylindrical and extend in or along its main axis in the axial direction of the bearing. The cross-sectional shape of the axial fixture part is not limited to a circular shape and can have a varying cross-sectional shape along the axial direction. In particular, the axial fixture part can have at least one radially projecting inner core thickening, which preferably thickens from the center of mass of the hydraulic bearing in the first and/or second axial direction toward the first and/or second axial end side of the hydraulic bearing and is arranged in a third radial direction and/or a fourth radial direction opposite the third radial direction. Here, preferably the third and fourth radial directions are respectively arranged perpendicular to the first and second radial directions.

The first inner core stop projection extends into the first fluid chamber in the first radial direction and can have at least one first axial first-end-side inner core stop surface in the first axial direction. The second inner core stop projection extends into the second fluid chamber in the second radial direction and can have at least one second axial first-end-side inner core stop surface in the first axial direction. The normal or normal vector of the first and second axial first-end-side inner core stop surfaces can be aligned substantially in the first axial direction. Preferably, the first and second inner core stop projections can be symmetrically shaped and/or arranged diametrically relative to a plane of the hydraulic bearing including the first and second axial directions and the third and fourth radial directions.

The cage can be designed in its basic form as a hollow cylinder or approximately as a hollow cylinder and has at least the first and second cage axial stop projections. Here, the cage can be formed at least partially from a dimensionally stable material, such as a plastic and/or a metal, such as aluminum. The cage can be formed in one piece and, in particular, can be manufactured as a single-piece component in a single processing step using an injection molding or (die-)casting method. For this purpose, the cage can be formed to be substantially undercut-free in at least two mutually perpendicular radial directions and in both axial directions. The axial end sides of the cage can be open or at least partially delimit the cage in the direction of the longitudinal axis. The axial end sides of the cage can be substantially completely covered with the material of the elastomer body. In particular, the cage can be substantially completely embedded in the elastomer body. However, the cage can also be at least partially exposed radially outward to facilitate connection to the outer sleeve. The cage can have, for example, two or four windows or through-holes in the radial direction, i.e., from the inside of the cage to the outside of the cage, which can be provided to form at least two fluid chambers for receiving a working fluid. Furthermore, the cage can at least partially form fluid channels that extend between the respective fluid chambers.

The first cage axial stop projection can extend or protrude in the first axial direction at a height between the center of mass of the hydraulic bearing and the first axial end side of the hydraulic bearing from the inside of the cage in the second radial direction. The first cage axial stop projection can have at least one first-end-side cage axial stop surface in the second axial direction. The second cage axial stop projection can extend or protrude in the first axial direction at a height between the center of mass of the hydraulic bearing and the first axial end side of the hydraulic bearing from the inside of the cage in the first radial direction. The second cage axial stop projection can have at least one second first-end-side cage axial stop surface in the second axial direction. The normal or normal vector of the first and second first-end-side cage axial stop surfaces can be aligned substantially in the second axial direction.

The cage can have at least one radially projecting cage thickening on its inside, which preferably thickens from the first and/or second axial end side of the hydraulic bearing in the second and/or first axial direction toward the center of mass of the hydraulic bearing and is arranged in the third radial direction and/or the fourth radial direction.

The elastomer body is formed, for example, from an elastically deformable plastic, such as an elastomer, which can deform elastically under load. The elastomer body comprises or forms a suspension spring. The suspension spring of the elastomer body can generate a spring force that counteracts the load under tensile and compressive loads in the axial and radial directions. In particular, the suspension spring can have greater rigidity in the first and second axial directions and the third and fourth radial directions than in the first and second radial directions. The elastomer body can completely or at least partially surround and/or embed the inner core and/or the cage and has two fluid chamber recesses. However, the elastomer body can also have further fluid chamber recesses, wherein these further fluid chamber recesses can form both radially and axially acting fluid chambers in the bearing. In addition, the elastomer body can form at least part of the fluid channel that connects the fluid chamber recesses. Furthermore, the elastomer body can preferably coat and/or cover the first and/or second axial first-end-side inner core stop surface as well as the first and/or second axial first-end-side cage stop surface, thus forming stop buffers.

The outer sleeve can be formed at least partially from a dimensionally stable material, such as a metal or plastic, which is suitable for being secured to an external component, such as a body part subject to vibration loading. The outer sleeve can be formed as a hollow cylinder or substantially as a hollow cylinder. The outer sleeve can have an axial extension that substantially corresponds to the axial extension of the cage and/or the elastomer body.

In the mounted state, the first axial first-end-side inner core stop surface and the first first-end-side cage axial stop surface and/or the second axial first-end-side inner core stop surface and the second first-end-side cage axial stop surface overlap and/or cover each other in the axial direction. The radial overlap amount can, for example, correspond to approximately 5 % to approximately 40 % or approximately 10 % to approximately 30 % of the radius of the bearing. Preferably, the first and/or second axial first-end-side inner core stop surfaces and the first and/or second first-end-side cage axial stop surfaces are formed such that even with a predetermined, maximum radial relative movement between the inner core and the cage, as seen in the axial direction, there is always a sufficient overlap between the first axial first-end-side inner core stop surface and the first first-end-side cage axial stop surface and/or the second axial first-end-side inner core stop surface and the second first-end-side cage axial stop surface. Furthermore, the first and/or second axial first- end-side inner core stop surfaces and the first and/or second first-end-side cage axial stop surfaces are preferably formed such that the normal vectors of the first axial first-end-side inner core stop surface and the first first-end-side cage axial stop surface and/or the second axial first-end-side inner core stop surface and the second first-end-side cage axial stop surface are aligned substantially opposite with respect to each other. In addition, the distance in the axial direction between the first axial first-end-side inner core stop surface and the first first-end-side cage axial stop surface and/or the second axial first-end-side inner core stop surface and the second first-end-side cage axial stop surface in the unloaded state of the hydraulic bearing corresponds to a predetermined maximum spring travel in the first axial direction during a relative movement between the inner core and the cage in the first axial direction. In particular, during the relative movement between the inner core and the cage, with the predetermined maximum spring travel in the first axial direction, surface contact occurs between the first axial first-end-side inner core stop surface and the first first-end-side cage axial stop surface and/or between the second axial first-end-side inner core stop surface and the second first-end-side cage axial stop surface and/or their respective stop buffers. Here, the relative movement between the inner core and the cage in the first axial direction is limited. The stop buffers can cushion an impact during maximum axial relative movement between the inner core and the cage in the first axial direction via the respective stop surfaces, thus increasing the durability of the hydraulic bearing.

Moreover, in the mounted state, at least part of the suspension spring can preferably be formed in the axial direction between a first radial first-end-side inner core thickening and a first radial second-end-side cage thickening, and between a second radial first-end-side inner core thickening and a second radial second-end-side cage thickening. This can advantageously increase the axial rigidity of the bearing. However, the suspension spring can also be formed between two cylinders and without the inner core and cage thickenings.

In a preferred embodiment of the hydraulic bearing, the elastomer body is formed to be substantially undercut-free at a first axial end side of the hydraulic bearing in the first axial direction and at a second axial end side of the hydraulic bearing in the second axial direction, and/or the elastomer body, the cage, and the inner core are formed to be substantially undercut-free in the region of the fluid chamber recesses at least in a first radial intersection direction perpendicular to the first and second radial directions and in a second radial intersection direction opposite to the first radial intersection direction.

Advantageously, the hydraulic bearing can be manufactured compactly and significantly more easily because its vulcanization component can be produced in a single manufacturing step in an injection mold or a casting mold. Here, the geometry of the axial end sides of the elastomer body, its fluid chamber recesses, and, if applicable, the fluid channels and the stop buffers above the respective stop surfaces of the inner core and the cage are formed without additional machining steps. This is achieved by forming the axial end side in the axial direction as well as the fluid chamber recesses and, if applicable, the fluid channels of the elastomer body and the stop buffers above the respective stop surfaces of the inner core and the cage substantially undercut-free in the first and second radial intersection directions. Preferably, the first radial intersection direction coincides with the third radial direction, and the second radial intersection direction coincides with the fourth radial direction.

“formed to be substantially undercut-free” means, in particular, that during the manufacture of the elastomer body or in the unloaded state of the elastomer body, there is no undercut in the corresponding direction, or that there is only a small amount of undercut, in particular only in easily deformable regions of the elastomer body. Moreover, “formed to be substantially undercut-free” can mean that in an mounted state of the bearing, there is no undercut on the elastomer body, or that there is only a small amount of undercut on the elastomer body, in particular only in easily deformable regions of the elastomer body. “substantially undercut-free” can, in particular, mean that during the manufacture of the elastomer body, it is possible to pull out a slider or open the mold in the corresponding direction without damaging or destroying the elastomer body.

During the manufacture of the vulcanization component using the injection molding mold, the inner core and the cage of the hydraulic bearing can first be inserted, preferably concentrically, into the interior of the mold. In some cases, a displacement of the inner core relative to the cage can also be provided in order to compensate for preloads of the elastomer body. Before injection molding, the inner core and the cage are brought into a predetermined position with respect to each other inside the mold. This predetermined position corresponds to the position of the inner core and the cage in an unloaded state of the hydraulic bearing. In particular, in the predetermined position, the axial direction of the inner core or the cage preferably corresponds approximately to the opening or closing direction of the mold, whereas the first and second radial intersection directions of the inner core or the cage correspond approximately to the pushing-in or pushing-out direction of one of the sliders. In addition, the windows of the cage are aligned inside the mold such that the sliders can be inserted through the respective windows to an end position in which the sliders each form the counterpart to the desired fluid chamber recesses and the shape of the stop buffers above the respective stop surfaces of the inner core and the cage. The sliders can also have portions that enclose the cage and form the radial outer surface of the elastomer body or the vulcanization component, in particular the fluid channels. After inserting the sliders into the mold, the elastomer material can be injected into the remaining cavity between the inner contour of the mold, inner core, cage, and slider and optionally be vulcanized. Subsequently, the sliders can be removed from the interior of the mold in the opposite direction, and the finished vulcanization component can be taken out from the interior of the mold and mounted into the outer sleeve in a subsequent step.

In a further preferred embodiment of the hydraulic bearing, the cage further has: first and second cage radial stop projections, wherein the first and second inner core stop projections cooperate with the first and second cage radial stop projections, respectively, so as to limit relative displacement of the inner core and the cage with respect to each other in the first radial direction and in the second radial direction.

Advantageously, in this embodiment, in addition to a predetermined first axial direction, the maximum linear bearing travels are also limited in a predetermined first and second radial direction of the hydraulic bearing, and no additional stops or stop plates are required in these directions outside the hydraulic bearing.

Here, the first inner core stop projection can have at least one first radial inner core stop surface in the first radial direction, and the second inner core stop projection can have at least one second radial inner core stop surface in the second radial direction. The normal vector of the first radial inner core stop surface can be oriented substantially in the first radial direction, and the normal vector of the second radial inner core stop surface can be oriented substantially in the second radial direction. Preferably, the first and second radial inner core stop surfaces of the respective first and second inner core stop projections can be symmetrically shaped and/or arranged diametrically relative to a plane of the hydraulic bearing including the first and second axial directions and the third and fourth radial directions.

The first cage radial stop projection can extend or protrude in the first axial direction at a height between the second axial end side of the hydraulic bearing and the first cage axial stop projection from the inside of the cage in the second radial direction. The first cage radial stop projection can have at least one first cage radial stop surface in the second radial direction. The second cage radial stop projection can extend or protrude in the first axial direction at a height between the second axial end side of the hydraulic bearing and the second cage axial stop projection from the inside of the cage in the first radial direction. The second cage radial stop projection can have at least one second cage radial stop surface in the first radial direction. Here, the normal vector of the first cage radial stop surface can be oriented substantially in the second radial direction, and the normal vector of the second cage radial stop surface can be oriented substantially in the first radial direction. Furthermore, the elastomer body can preferably coat and/or cover the first and/or second radial inner core stop surface and the first and/or second cage radial stop surface, thus forming stop buffers.

Preferably, the first and/or second radial inner core stop surfaces and the first and/or second cage radial stop surfaces are formed such that the normal vectors of the first radial inner core stop surface and the first cage radial stop surface and/or the second radial inner core stop surface and the second cage radial stop surface are oriented substantially opposite with respect to each other. In addition, the distance in the radial direction between the first radial inner core stop surface and the first cage radial stop surface in the unloaded state of the hydraulic bearing corresponds to a predetermined maximum spring travel in the first radial direction during a relative movement between the inner core and the cage in the first radial direction. In particular, during relative movement between the inner core and the cage, at the predetermined maximum spring travel in the first radial direction, surface contact occurs between the first radial inner core stop surface and the first cage radial stop surface and/or their respective stop buffers. This limits the relative movement between the inner core and the cage in the first radial direction. The same applies to the second radial inner core stop surface and the second cage radial stop surface. Advantageously, the stop buffers can cushion a maximum radial relative movement between the inner core and the cage in the first and second radial directions via the respective stop surfaces, thus increasing the durability of the hydraulic bearing.

In a further preferred embodiment of the hydraulic bearing, the cage further has: first and second support ribs; wherein the first and second support ribs are each formed between a radial outer boundary of the cage and the first and second cage axial stop projections.

Advantageously, the first and second support ribs increase the rigidity of the hydraulic bearing when loaded in the first axial direction and improve its durability.

The first and second support ribs are preferably shaped such that, when the hydraulic bearing is loaded in the first axial direction, the axial forces acting on the first and second cage axial stop surfaces on the first end side are redirected and distributed to the hollow cylinder-shaped outer structure of the cage. In particular, the first support rib can thicken in the first radial direction from the first cage axial stop projection to the radial outer boundary of the cage, and the second support rib can thicken in the second radial direction from the second cage axial stop projection to the radial outer boundary of the cage.

In a further preferred embodiment of the hydraulic bearing, the cage further has: third and fourth cage axial stop projections, wherein the first and second inner core stop projections cooperate with the third and fourth cage axial stop projections, respectively, so as to limit relative displacement of the inner core and the cage with respect to each other in the second axial direction, and optionally wherein the cage further has: third and fourth support ribs; wherein the third and fourth support ribs are each formed between a radial outer boundary of the cage and the third and fourth cage axial stop projections.

Advantageously, in addition to the predetermined first axial direction, the maximum linear displacement path in an axial direction of the hydraulic bearing opposite to the predetermined first axial direction is also limited, and no additional stops or stop plates are required in this direction outside the hydraulic bearing. The third and fourth support ribs also increase the rigidity of the hydraulic bearing when loaded in the second axial direction and improve durability.

Here, the first inner core stop projection can have at least one first axial second-end-side inner core stop surface in the second axial direction, and the second inner core stop projection can have at least one second axial second-end-side inner core stop surface in the second axial direction. The above explanations regarding the first axial first-end-side inner core stop surface, the second axial first-end-side inner core stop surface, the first cage axial stop projection, and/or the second cage axial stop projection also apply accordingly to the first axial second-end-side inner core stop surface, the second axial second-end-side inner core stop surface, the third cage axial stop projection, and/or the fourth cage axial stop projection.

The third and fourth support ribs are preferably shaped such that, when the hydraulic bearing is loaded in the second axial direction, the axial forces acting on the first and second second-end-side cage axial stop surfaces are redirected and distributed to the hollow cylinder-shaped outer structure of the cage. In particular, the third support rib can thicken in the first radial direction from the third cage axial stop projection to the radial outer boundary of the cage and the fourth support rib can thicken in the second radial direction from the fourth cage axial stop projection to the radial outer boundary of the cage.

In a further preferred embodiment, the elastomer body forms a first and a second first- end-side fluid chamber wall which respectively delimit the first and second fluid chambers at a first axial end side of the hydraulic bearing in the first axial direction, and a first and a second second-end-side fluid chamber wall which respectively delimit the first and second fluid chambers at a second axial end side of the hydraulic bearing in the second axial direction; wherein, in a plane of the hydraulic bearing which contains the first and second axial directions and the first and second radial directions, the length of the first first-end-side fluid chamber wall and the length of the first second-end-side fluid chamber wall are substantially equal; and/or the length of the second first-end-side fluid chamber wall and the length of the second second-end-side fluid chamber wall are substantially equal; and wherein optionally the length of the first and second first-end-side fluid chamber wall and the length of the first and second second-end-side fluid chamber wall between the inner core and the cage are substantially equal.

Advantageously, due to the substantially equal length of the first and second end-

side fluid chamber walls and the hydraulic bearing configuration without third and fourth cage axial stop projections, resulting in an asymmetric design with respect to the x-y plane, a uniform relative movement between the inner core and the cage, in particular in the first and second radial directions and the first and second axial directions, and balanced vibration behavior in the first and second radial directions is made possible.

Preferably, in the plane of the hydraulic bearing containing the first and second axial directions and the first and second radial directions, the thickness of the first and second first-end-side fluid chamber walls and the thickness of the first and second second-end-side fluid chamber walls can also be substantially equal between the respective fluid chamber and the end side of the hydraulic bearing. This simplifies the manufacturing process of the elastomer body, since there are no significant differences in length and thickness in the elastomer body material of the fluid chamber walls. Moreover, in the plane of the hydraulic bearing containing the first and second axial directions and the first and second radial directions, the longitudinal ends of the respective first-end-side fluid chamber walls can preferably abut on a radially inner side of the first or second cage axial stop projection and to the fixture part of the inner core in the second axial direction between the first end side of the hydraulic bearing and the inner core stop projection. Furthermore, the longitudinal ends of the respective second-end-side fluid chamber walls can preferably abut on a radially inner side of the hollow cylinder-shaped structure of the cage and to the fixture part of the inner core in the first axial direction between the second end side of the hydraulic bearing and the inner core stop projection. In particular, in the plane of the hydraulic bearing containing the first and second axial directions and the first and second radial directions, first and second first-end-side angles between the longitudinal axis of the hydraulic bearing and an outer side of the first and second first-end fluid chamber walls facing away from the respective fluid chamber can be smaller than first and second second-end-side angles between the longitudinal axis of the hydraulic bearing and an outer side of the first and second second-end fluid chamber walls facing away from the respective fluid chamber. Despite the asymmetric design of the hydraulic bearing, the respectively different first- and second-end-side angles in particular allow longer first-end-side fluid chamber walls than with equally large first- and second-end-side angles, wherein an extension of the first-end-side fluid chamber walls improves the damping behavior of the hydraulic bearing in the first and second radial directions.

A second aspect for achieving the object of the present disclosure relates to a method for manufacturing a hydraulic bearing, wherein the method comprises the following steps: inserting an inner core into a mold, inserting a cage into the mold such that the cage surrounds the inner core, closing the mold, inserting sliders, for example radial sliders, into the mold, injecting an elastomer material into the mold, forming an elastomer body from the elastomer material to shape a vulcanization component, wherein the vulcanization component has the inner core, the elastomer body and the cage, pulling out the sliders, opening the mold, demolding the vulcanization component from the mold, and connecting the vulcanization component to an outer sleeve, wherein the elastomer body elastically connects the inner core and the cage to allow relative displacement of the inner core and the cage with respect to each other in a first axial direction, a second axial direction opposite to the first axial direction, a first radial direction and a second radial direction opposite to the first radial direction, respectively, and has first and second fluid chamber recesses, wherein the first and second fluid chamber recesses are each filled with a working fluid and bounded radially outwardly by the outer sleeve to form first and second fluid chambers, respectively, wherein the first and second fluid chambers are fluidically connected to each other via a fluid channel and are designed such that fluid exchange takes place between the first and second fluid chambers via the fluid channel upon relative displacement of the inner core and the cage with respect to each other in the first and second radial directions, respectively, wherein the inner core has: first and second inner core stop projections, wherein the first inner core stop projection extends in the first radial direction into the first fluid chamber and the second inner core stop projection extends in the second radial direction into the second fluid chamber, and wherein the cage has:first and second cage axial stop projections, wherein the first and second inner core stop projections cooperate with the first and second cage axial stop projections, respectively, so as to limit the relative displacement of the inner core and the cage with respect to each other in the first axial direction.

For the above-mentioned aspects and in particular for related preferred embodiments, the statements made above or below regarding the embodiments of the respective other aspects also apply.

In the following, individual embodiments for achieving the object will be described by way of example with reference to the figures. Here, some of the individual embodiments described have features that are not absolutely necessary to implement the claimed subject matter, but which provide advantageous properties in certain applications. Thus, embodiments that do not have all the features of the embodiments described below are also to be considered as falling within the scope of the described technical teaching. Furthermore, to avoid unnecessary repetition, certain features will be mentioned only in relation to individual embodiments described below. It should be noted that the individual embodiments should therefore not only be considered in isolation, but also in conjunction with one another. Based on this conjunction, the person skilled in the art will recognize that individual embodiments can also be modified by incorporating one or more features of other embodiments. It should be noted that a systematic combination of the individual embodiments with one or more features described with reference to other embodiments may be desirable and useful and should therefore be considered and regarded as encompassed by the description.

### BRIEF DESCRIPTION OF THE FIGURES

FIG. 1A shows a perspective view of an inner core of a hydraulic bearing of the present disclosure.

FIG. 1B shows a perspective view of an elastomer body of the hydraulic bearing of the present invention.

FIG. 1C shows a perspective view of a cage of the hydraulic bearing of the present disclosure.

FIG. 1D shows a perspective view of an outer sleeve of the hydraulic bearing of the present disclosure.

FIG. 2 shows a perspective view of the hydraulic bearing of the present disclosure in the connected state of the vulcanization component and outer sleeve.

FIG. 3A shows a first side view of the inner core of the hydraulic bearing of the present disclosure.

FIG. 3B shows a second side view of the inner core of the hydraulic bearing of the present disclosure.

FIG. 3C shows a first frontal view of a first axial end side of the inner core of the hydraulic bearing of the present disclosure.

FIG. 4A shows a frontal view of a second axial end side of the cage of the hydraulic bearing of the present disclosure.

FIG. 4B shows a first side view of the cage of the hydraulic bearing of the present disclosure.

FIG. 4C shows a second side view of the cage of the hydraulic bearing of the present disclosure.

FIG. 4D shows a frontal view of a first axial end side of the cage of the hydraulic bearing of the present disclosure.

FIG. 5A shows a frontal view of a second axial end side of the hydraulic bearing of the present disclosure.

FIG. 5B shows a first cross-sectional view of the hydraulic bearing of the present disclosure.

FIG. 5C shows a second cross-sectional view of the hydraulic bearing of the present disclosure.

FIG. 5D shows a frontal view of a first axial end side of the hydraulic bearing of the present disclosure.

### DETAILED DESCRIPTION OF THE FIGURES

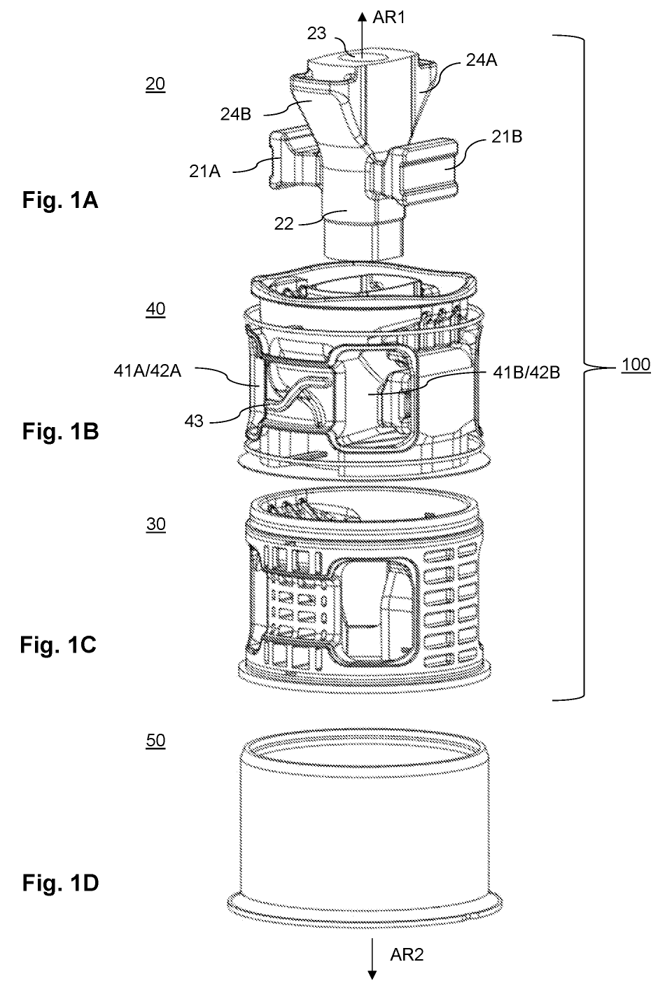

FIGS. 1A to 1D show the individual components of a substantially cylindrical hydraulic bearing 10 of the present disclosure, and in particular an inner core 20, an elastomer body 40, a cage 30, and an outer sleeve 50, each in a perspective view and in a non-mounted state. The inner core 20, the elastomer body 40, and the cage 30 together form a vulcanization component 100, which is mounted into the outer sleeve 50. To manufacture the vulcanization component 100, in a first step, the inner core 20 and the cage 30 are concentrically placed into a mold so that the cage 30 surrounds the inner core 20. In addition, sliders are inserted into the mold and the space between the inner core 20 and the cage 30 in the radial direction to define the desired shape for the elastomer body 40. In the next manufacturing steps, elastomer material is injected into the cavity between mold, sliders, inner core 20, and cage 30, and the elastomer body 40 is vulcanized to the inner core 20 and the cage 30.

Here, the elastomer body 40 elastically connects the inner core 20 to the cage 30. The inner core 20 in FIG. 1A has an axial fixture part 22, first and second innercore stop projections 21A and 21B, and first and second radial first-end-side inner core thickenings 24A and 24B and is preferably made of a dimensionally stable material, such as a metal or plastic. The axial fixture part 22 is formed to be substantially cylindrical, extends in or along its main axis in a first axial direction AR1 and a second axial direction AR2 opposite to the first axial direction AR1 and forms an axial through-hole 23 as a mounting recess. The hydraulic bearing 10 can be fixed to an external component by means of a screw or the like inserted into the mounting recess. The cage 30 in FIG. 1C is also made of a dimensionally stable material, such as plastic, and in its basic shape is approximately formed as a hollow cylinder. The axial end sides of the cage 30 are open, and in the radial direction, the cage 30 has four windows or four through-recesses through which the sliders are passed during the manufacture of the elastomer body 40. The elastomer body 40 in FIG. 1B substantially encloses the inner core 20 after the vulcanization step and has first and second fluid chamber recesses 41A and 41B and a fluid channel 43 connecting the fluid chamber recesses 41A and 41B. The outer sleeve 50 in FIG. 1D is designed as a hollow cylinder made of a dimensionally stable material, wherein the outer contour of the outer sleeve 50 can be connected to another external component. The axial extent of the outer sleeve 50 substantially corresponds to the axial extent of the vulcanization component 100, and the inner diameter of the outer sleeve 50 is selected such that the vulcanization component 100 can be pressed into it up to an axial stop flange.

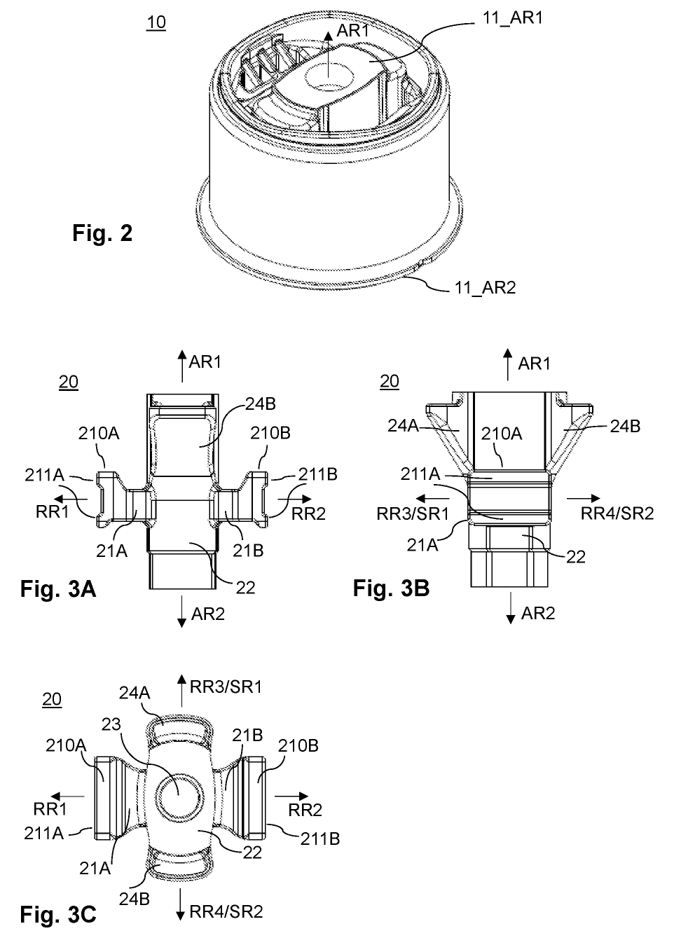

FIG. 2 shows a perspective view of the hydraulic bearing 10 of the present disclosure in the connected state of the vulcanization component 100 and the outer sleeve 50. Here, the hydraulic bearing 10 has a first axial end side 11_AR1 in the first axial direction AR1 and a second axial end side 11_AR2 in a second axial direction AR2 opposite to the first axial direction AR1. After mounting the vulcanization component 100 into the outer sleeve 50, a part of the inner side of the outer sleeve 50 delimits the first and second fluid chamber recesses 41A and 41B and the fluid channel 43 (FIG. 1B) in a radially outward direction and seals them in a fluid-tight manner. Before and/or during mounting the vulcanization component 100 into the outer sleeve 50, the fluid chamber recesses 41A and 41B and the fluid channel 43 are filled with a working fluid 44. By connecting the vulcanization component 100 to the outer sleeve 50, a self-contained fluid system with a first and second fluid chamber 42A and 42B and the fluid channel 43 is created in the hydraulic bearing 10.

FIGS. 3A to 3C show the inner core 20 of the hydraulic bearing 10 of the present disclosure in a first and second side view, as well as in a first frontal view looking toward the first axial end side 11_AR1. A second frontal view of the second axial end side 11_AR2 of the inner core 20, opposite to the first frontal view, is not shown here. Here, the first side view shows the inner core 20 with a view onto a first plane which contains the first and second axial directions AR1 and AR2 and a first radial direction RR1 and a second radial direction RR2 opposite to the first radial direction RR1, and the second side view shows the inner core 20 with a view onto a second plane which contains the first and second axial directions AR1 and AR2 and a third radial direction RR3 and a fourth radial direction RR4 opposite to the third radial direction RR3. The first and second radial directions RR1 and RR2 are each perpendicular to the third and fourth radial directions RR3 and RR4. The third and fourth radial directions RR3 and RR4 each correspond to a first and second radial intersection direction SR1 and SR2, into which the sliders are inserted into the mold and into the windows of the cage 30 during the manufacture of the elastomer body 40. The first frontal view shows a view of a third plane containing the first, second, third, and fourth radial directions RR1, RR2, RR3, and RR4. The center of the hydraulic bearing 10 is approximately the center of mass at the intersection point between the first, second, and third planes.

Like in FIG. 1A, the cylinder-shaped axial fixture part 22 extends in the first and second axial directions AR1 and AR2 and has the through-hole 23. The first and second inner core stop projections 21A and 21B are arranged diametrically to each other with respect to the second plane and extend in the first radial direction RR1 and in the second radial direction RR2. The first inner core stop projection 21A has a first axial first-end-side inner core stop surface 210A with a normal vector in the first axial direction AR1 and a first radial inner core stop surface 211A with a normal vector in the first radial direction RR1. The second inner core stop projection 21B has a second axial first-end-side inner core stop surface 210B with a normal vector in the first axial direction AR1 and a second radial inner core stop surface 211B with a normal vector in the second radial direction RR2. In a further embodiment with axial stops in the first and second axial directions, the first and second inner core stop projections 21A and 21B can additionally have a first and second axial second-end inner core stop surface, each with a normal vector in the second axial direction AR2. The first and second radial first-end inner core thickenings 24A and 24B are arranged diametrically opposite to each other with respect to the first plane and extend in the third radial direction RR3 and in the fourth radial direction RR4, wherein the first and second radial first-end-side inner core thickenings 24A and 24B each thicken from the center of mass of the hydraulic bearing 10 in the first axial direction AR1 toward the first axial end side 11_AR1 of the hydraulic bearing 10.

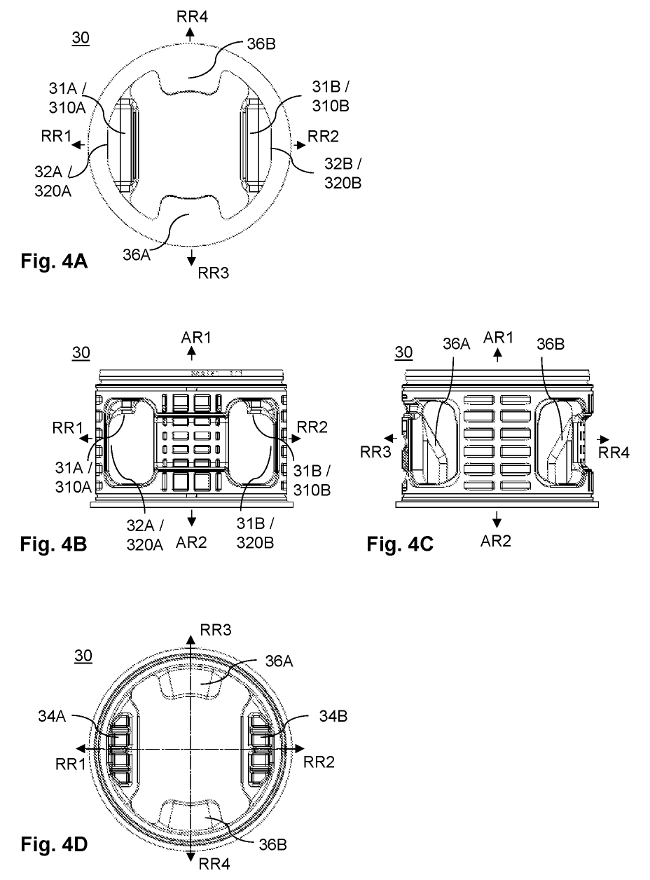

FIGS. 4A to 4D show the cage 30 of the hydraulic bearing 10 of the present disclosure in the second frontal view looking toward the second axial end side 11_AR2, in the first side view looking toward the first plane, in the second side view looking toward the second plane, and in the first frontal view looking toward the first axial end side 11_AR1.

The four radial windows of the cage 30 for forming the first and second fluid chambers 42A and 42B are radially oriented such that the sliders can be inserted into the cage 30 in the first and second intersection directions SR1 and SR2 during manufacture of the vulcanization component 100. The cage 30 has first and second cage axial stop projections 31A and 31B, first and second cage radial stop projections 32A and 32B, first and second support ribs 34A and 34B, and first and second radial second-end-side cage thickenings 36A and 36B. The first and second cage axial stop projections 31A and 31B respectively extend in the first axial direction A1 at a height between the center of mass of the hydraulic bearing 10 and the first axial end side 11_AR1 of the hydraulic bearing 10 from the inside of the cage in the second radial direction RR2 and in the first radial direction RR1 toward the main axis of the hydraulic bearing 10. The first and second support ribs 34A and 34B are arranged between the inside of the cage hollow cylinder and the first and second cage axial stop projections 31A and 31B, respectively, for deflecting the axial forces onto the cage hollow cylinder. The first cage axial stop projection 31A has a first first-end-side cage axial stop surface 310A with a normal vector in the second axial direction AR2, and the first cage radial stop projection 32A has a first cage radial stop surface 320A with a normal vector in the second radial directionRR2. The second cage axial stop projection 31B has a second first-end-side cage axial stop surface 310B with a normal vector in the second axial direction AR2, and the second cage radial stop projection 32B has a second cage radial stop surface 320A with a normal vector in the first radial direction RR1. In the further embodiment with axial stops in the first and second axial directions, the cage 30 can additionally have third and fourth second-end-side support ribs and third and fourth cage axial stop projections arranged thereon, each with first and second second-end-side cage axial stop surfaces and a normal vector in the first axial direction AR1. The first and second radial second-end-side cage thickenings 36A and 36B are arranged diametrically to each other with respect to the first plane and extend in the fourth radial direction RR4 and in the third radial direction RR3,respectively, wherein the first and second radial second-end-side cage thickenings 36A and 36B thicken from the first axial end side 11_AR1 of the hydraulic bearing 10 in the second axial direction AR2 respectively toward the second axial end side 11_AR2 of the hydraulic bearing 10.

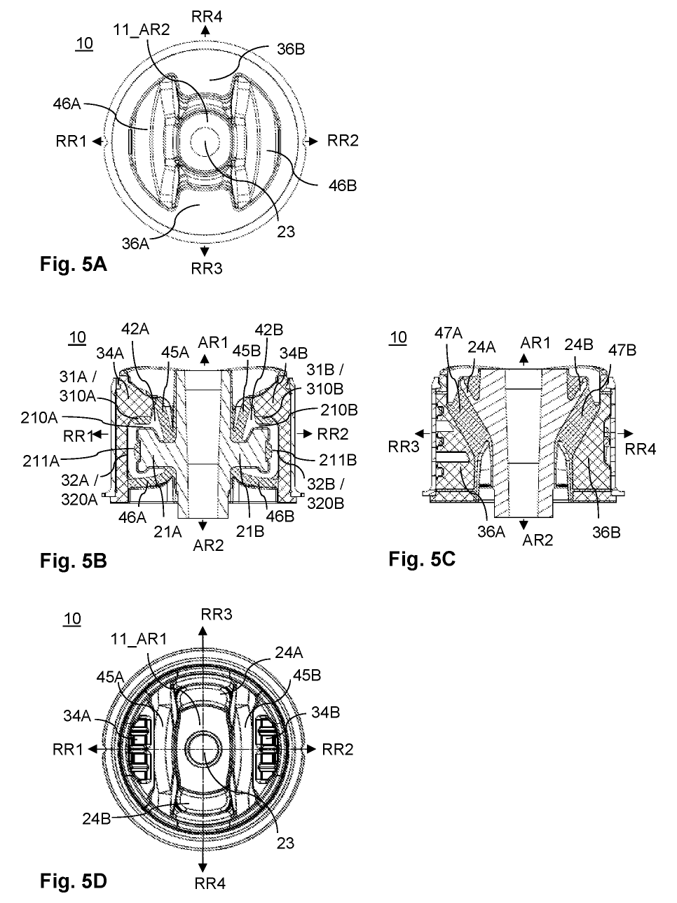

FIGS. 5A to 5D show the hydraulic bearing 10 of the present disclosure in the mounted state in the second frontal view looking toward the second axial end side 11_AR2, in a first cross-sectional view in the first plane, in a second cross-sectional view in the second plane, and in the first frontal view looking at the first axial end side 11_AR1.

After the vulcanization body 100 is manufactured and mounted into the outer sleeve 50, the first and second fluid chambers 42A and 42B filled with the working fluid 44 and the fluid channel 43 are formed. The first and second fluid chambers 42A and 42B are each bounded radially outwardly by the outer sleeve 50 and radially inwardly by the elastomer body 40 in the first and second axial directions AR1 and AR2 and in both circumferential directions, and are connected via the fluid channel 43. The elastomer body 40 is diametrically shaped with respect to the first and second planes and, with respect to the second plane, forms diametrical first and second first-end-side fluid chamber walls 45A and 45B on the first end side 11_AR1 and diametrical first and second second-end-side fluid chamber walls 46A and 46B on the second end side 11_AR2 as axial outer boundaries of the first and second fluid chambers 42A and 42B. In the first plane, the longitudinal ends of the first and second first-end-side fluid chamber walls 45A and 45B each abut on a radially inner side of the first and second cage axial stop projections 310A and 310B and the fixture part 22 of the inner core 20 between the first end side 11_AR1 and the first and second inner core stop projections 21A and 21B. Moreover, in the first plane, the longitudinal ends of the first and second second-end-side fluid chamber walls 46A and 46 abut on a radially inner side of the hollow cylinder-shaped structure of the cage 30 and the fixture part 22 of the inner core 20 between the second end face 11_AR2 and the first and second inner core stop projections 21A and 21B.here, the lengths and thicknesses of the first-end-side and second-end-side fluid chamber walls 45A, 45B, 46A and 46B in the first plane are each substantially equal, while a first and second first-end-side angle between the longitudinal axis of the hydraulic bearing 10 and an outer side of the respective first and second first-end-side fluid chamber walls 45A and 45B is smaller than a first and second second-end-side angle between the longitudinal axis of the hydraulic bearing 10 and an outer side of the first and second second-end-side fluid chamber walls 46A and 46B.

The first inner core stop projection 21A extends in the first radial direction RR1 into the first fluid chamber 42A, and the second inner core stop projection 21B extends in the second radial direction RR2 into the second fluid chamber 42B. Here, the first axial first-end-side inner core stop surface 210A and the first first-end-side cage axial stop surface 310A, which are oriented against each other, and the second axial first-end-side inner core stop surface 210B and the second first-end-side cage axial stop surface 310B, which are oriented against each other, substantially overlap in the axial direction and limit a relative movement between the inner core 30 and the cage 30 in the first axial direction AR1, wherein the first and second support ribs 34A and 34B deflect the axial forces to the cage hollow cylinder when the respective axial stops come into contact with each other. The first radial first-end-side inner core stop surface 211A and the first cage radial stop surface 320A, which are oriented against each other, substantially overlap in the first radial direction RR1,and the second radial first-end-side inner core stop surface 211B and the second cage radial stop surface 320B, which are oriented against each other, substantially overlap in the first radial direction RR2 and each limit a relative movement between the inner core 20 and the cage 30 in the first and second radial direction RR1 and RR2. Within the first and second fluid chambers 42A and 42B, the elastomer body 40 covers the first and second axial first-end-side inner core stop surfaces 210A and 210B, the first and second radial inner core stop surfaces 211A and 211B, the first and second first-end-side cage axial stop surfaces 310A and 310B, and the first and second cage radial stop surfaces 320A and 320B, and forms an elastic stop buffer in each case to prevent coming into contact of the first-end-side inner core stop surfaces 210A and 210B with the first-end-side cage axial stop surfaces 310A and 310B in the first axial direction AR1 as well as the radial inner core stop surfaces 211A and 211B and the cage radial stop surfaces 320A and 320B in the first and second radial directions RR1 and RR2.

Furthermore, in the mounted state, the elastomer body 40 forms, in the second plane in the axial direction, a first axial suspension spring 47A between the first radial first-end-side inner core thickening 24A and the first radial second-end-side cage thickening 36A, and a second axial suspension spring 47B between the second radial first-end-side inner core thickening 24A and the second radial second-end-side cage thickening 36B, wherein the axial rigidity of the hydraulic bearing 10 is increased by the thickenings on the inner core 20 and the cage 30.

1. A hydraulic bearing, comprising:
an inner core;
a cage which surrounds the inner core;
an elastomer body which extends between the inner core and the cage and elastically connects them to each other to allow relative displacement of the inner core and the cage with respect to each other in a first axial direction, a second axial direction opposite to the first axial direction, a first radial direction and a second radial direction opposite to the first radial direction, respectively; and
an outer sleeve which encloses the cage;
wherein the elastomer body has:
a first fluid chamber recess and a second fluid chamber recess
wherein the first and the second fluid chamber recesses are each filled with a working fluid and bounded radially outwardly by the outer sleeve to form a first fluid chamber and a second fluid chambers respectively;
wherein the first and the second fluid chambers are fluidically connected to each other via a fluid channel and are designed such that fluid exchange takes place between the first and the second fluid chambers via the fluid channel upon relative displacement of the inner core and the cage with respect to each other in the first and second radial directions, respectively,
wherein the inner core has:
a first and a second inner core stop projections , wherein the first inner core stop projection extends in the first radial direction into the first fluid chamber and the second inner core stop projection extends in the second radial direction into the second fluid chamber wherein the cage has:
a first and a second cage axial stop projections , wherein the first and the second inner core stop projections cooperate with the first and the second cage axial stop projections respectively, so as to limit the relative displacement of the inner core and the cage with respect to each other in the first axial direction.

2. The hydraulic bearing according to claim 1, wherein the elastomer body is formed to be substantially undercut-free at a first axial end side of the hydraulic bearing in the first axial direction and at a second axial end side of the hydraulic bearing in the second axial direction and/or
wherein the elastomer body the cage and the inner core are formed to be substantially undercut-free in the region of the fluid chamber recesses at least in a first radial intersection direction perpendicular to the first and second radial directions and in a second radial intersection direction opposite to the first radial intersection direction.

3. The hydraulic bearing according to claim 1, wherein the cage further includes:
a first and a second cage radial stop projections , wherein the first and second inner core stop projections cooperate with the first and second cage radial stop projections respectively, so as to limit relative displacement of the inner core and the cage with respect to each other in the first radial direction and in the second radial direction.

4. The hydraulic bearing according to claim 1, wherein the cage further includes: a first and a second support ribs , wherein the first and second support ribs are each formed between a radial outer boundary of the cage and the first and the second cage axial stop projections.

5. The hydraulic bearing according to claim 1, wherein the cage further includes:
a third and a fourth cage axial stop projections, wherein the first and the second inner core stop projections cooperate with the third and the fourth cage axial stop projections, respectively, so as to limit relative displacement of the inner core and the cage with respect to each other in the second axial direction and optionally
wherein the cage further includes:
a third and a fourth support ribs;
wherein the third and the fourth support ribs are each formed between a radial outer boundary of the cage and the third and the fourth cage axial stop projections.

6. The hydraulic bearing according to claim 5, wherein the elastomer body forms a first and a second first-end-side fluid chamber wall which respectively delimit the first and the second fluid chambers at a first axial end side of the hydraulic bearing in the first axial direction and a first and a second second-end-side fluid chamber wall which respectively delimit the first and second fluid chambers at a second axial end side of the hydraulic bearing in the second axial direction,
wherein, in a plane of the hydraulic bearing which contains the first and the second axial directions and the first and the second radial directions (the length of the first first-end-side fluid chamber wall and the length of the first second-end-side fluid chamber wall are substantially equal; and/or the length of the second first-end-side fluid chamber wall and the length of the second second-end-side fluid chamber wall are substantially equal.

7. A method for manufacturing a hydraulic bearing wherein the method comprises the following steps:
inserting an inner core into a mold;
inserting a cage into the mold such that the cage surrounds the inner core closing the mold;
inserting sliders into the mold;
injecting an elastomer material into the mold;
forming an elastomer body from the elastomer material to shape a vulcanization component wherein the vulcanization component has the inner core the elastomer body and the cage;
pulling out the sliders;
opening the mold;
demolding the vulcanization component from the mold; and
connecting the vulcanization component to an outer sleeve, wherein the elastomer body elastically connects the inner core and the cage to allow relative displacement of the inner core and the cage with respect to each other in a first axial direction a second axial direction opposite to the first axial direction a first radial direction and a second radial direction opposite to the first radial direction respectively, and has first and second fluid chamber recesses;
wherein the first and second fluid chamber recesses are each filled with a working fluid and bounded radially outwardly by the outer sleeve () to form a first and a second fluid chambers respectively;
wherein the first and the second fluid chambers are fluidically connected to each other via a fluid channel and are designed such that fluid exchange takes place between the first and second fluid chambers via the fluid channel upon relative displacement of the inner core and the cage to each other in the first and second radial directions respectively;
wherein the inner core has:
a first and a second inner core stop projections, wherein the first inner core stop projection extends in the first radial direction into the first fluid chamber and the second inner core stop projection extends in the second radial direction into the second fluid chamber , and
wherein the cage has:
a first and a second cage axial stop projections , wherein the first and second inner core stop projections cooperate with the first and the second cage axial stop projections respectively, so as to limit the relative displacement of the inner core and the cage with respect to each other in the first axial direction.
